(19) United States
(12) Patent Application Publication
(10) Pub. No.: US 2023/0023406 A1
(43) Pub. Date: Jan. 26, 2023

(54) INFORMATION PROCESSING DEVICE, INFORMATION PROCESSING METHOD, AND PROGRAM

(71) Applicant: Panasonic Holdings Corporation, Osaka (JP)

(72) Inventors: Rei HASEGAWA, Osaka (JP); Yuzo MORIUCHI, Mie (JP); Hideki KANEMOTO, Kanagawa (JP)

(21) Appl. No.: 17/758,310

(22) PCT Filed: Mar. 19, 2020
(86) PCT No.: PCT/JP2020/012315

§ 371 Date: Jul. 1, 2022

(30) Foreign Application Priority Data
Jan. 6, 2020 (JP) 2020-000280

(51) Int. Cl. H04W 16/20; H04W 24/02

(52) U.S. Cl. CPC H04W 16/20; H04W 24/02

(57) ABSTRACT

Provided are an information processing device, an information processing method, and a program that enable construction of a wireless system with consideration given to interference with the surroundings of a certain area. This information processing device is provided with: a first evaluation unit that evaluates a distribution of first wireless radio waves entering the inside of a certain area when wireless radio waves are radiated from one or more transmission points set outside the area; and a determination unit that determines, on the basis of the evaluation result regarding the distribution of the first wireless radio waves, information about the disposition candidate position of a wireless base station to be disposed inside the area.

### TECHNICAL FIELD

The present disclosure relates to an information processing apparatus, an information processing method, and a program.

### BACKGROUND ART

In a case where a radio system is built in a certain specific area by placing a radio base station in the certain specific area, placement of the radio base station is determined such that communication quality in the certain specific area satisfies a desired quality.

### CITATION LIST

### Patent Literature

### PTL 1

Japanese Patent Application Laid-Open No. 2006-333236

### SUMMARY OF INVENTION

### Technical Problem

There is room for discussion on building a radio system taking into account the impact (e.g., interference) given by the radio system to surroundings of a specific area.

One non-limiting and exemplary embodiment facilitates providing an information processing apparatus, an information processing method, and a program each making it possible to build a radio system taking into account the interference given by the radio system to surroundings of a specific area.

An information processing apparatus according to one example of the present disclosure includes: a first evaluator that evaluates a distribution of a first radio wave intruding into a certain area when a radio wave is radiated from one or a plurality of transmission points configured outside of the certain area; and a determiner that determines information on a placement candidate position of a radio base station to be placed inside of the certain area, based on an evaluation result on the distribution of the first radio wave.

An information processing method according to one example of the present disclosure includes: evaluating, by an information processing apparatus, a distribution of a first radio wave intruding into a certain area when a radio wave is radiated from one or a plurality of transmission points configured outside of the certain area; and determining, by the information processing apparatus, information on a placement candidate position of a radio base station to be placed inside of the certain area, based on an evaluation result on the distribution of the first radio wave.

A program according to one example of the present disclosure causes an information processing apparatus to execute processing including: evaluating a distribution of a first radio wave intruding into a certain area when a radio wave is radiated from one or a plurality of transmission points configured outside of the certain area; and determining information on a placement candidate position of a radio base station to be placed inside of the certain area, based on an evaluation result on the distribution of the first radio wave.

It should be noted that general or specific embodiments may be implemented as a system, an apparatus, a method, an integrated circuit, a computer program, a recording medium, or any selective combination thereof.

According to one example of the present disclosure, it is made possible to build a radio system taking into account the impact given by the radio system to surroundings of a specific area.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an example of a limited area in which radio base stations of a secondary use system are provided;

FIG. 2 is a diagram illustrating an exemplary system configuration according to Embodiment 1 of the present disclosure;

FIG. 3 is a block diagram illustrating an exemplary configuration of an information processing apparatus according to Embodiment 1 of the present disclosure;

FIG. 4 is a diagram illustrating an example of an interference management boundary in Embodiment 1 of the present disclosure;

FIG. 5 is a diagram illustrating an example of an evaluation result on interference in Embodiment 1 of the present disclosure;

FIG. 6 is a diagram illustrating an example of an evaluation result on service quality in Embodiment 1 of the present disclosure;

FIG. 7 is a flowchart illustrating an example of processing for determining placement of a radio base station in Embodiment 1 of the present disclosure;

FIG. 8 is a diagram illustrating a first example of placement of transmission points according to Embodiment 2 of the present disclosure;

FIG. 9 is a diagram illustrating a second example of placement of transmission points according to Embodiment 2 of the present disclosure; and

FIG. 10 is a block diagram illustrating an exemplary configuration of an information processing apparatus according to Embodiment 2 of the present disclosure.

### DESCRIPTION OF EMBODIMENTS

Hereinafter, preferred embodiments of the present disclosure will be described in detail with reference to the accompanying drawings. In the specification and drawings, like reference signs are assigned to component elements having substantially the same functions, and their descriptions will not be repeated.

### Embodiment 1

A radio system is built, in a specific area, such as a factory or a shopping mall (hereinafter, may be referred to as a “limited area,”) by placing one or more radio base stations each providing a coverage for the specific area. In this case, the placement of a radio base station(s) is made such that the radio communication quality in the limited area is more favorable. Note that, the limited area is an area that is spatially divided by, for example, a wall or the like. Alternatively, the limited area may correspond to a local area or the like where an individual area owner (e.g., entity providing a radio service) is present. When radio services are provided by different area owners in an area that is not spatially divided by, for example, a wall or the like, a plurality of limited areas associated respectively with the area owners may be defined in the area. When radio services are provided to an underground mall and a passage of a station, which are not spatially divided, for example, the area of the underground mall and the area including the passage of the station may be defined as limited areas different from each other. Further, the limited areas correspond to areas conceptually divided by, for example, latitude and longitude.

Use of a radio system that at least partly shares a frequency band used by a certain radio system (may be referred to as a “primary use system”) in a limited area has been discussed (the radio system that at least partly shares the frequency band may be referred to as a “secondary use system”). In this case, a radio wave radiated from a radio base station of the secondary use system possibly leaks outside of the limited area in this case. Note that, the primary use system may be a radio system that has already been in operation (may be referred to as an “existing radio system”) or may be a radio system to be built from now on. Further, a plurality of secondary use systems may form a primary use system and a secondary use system.

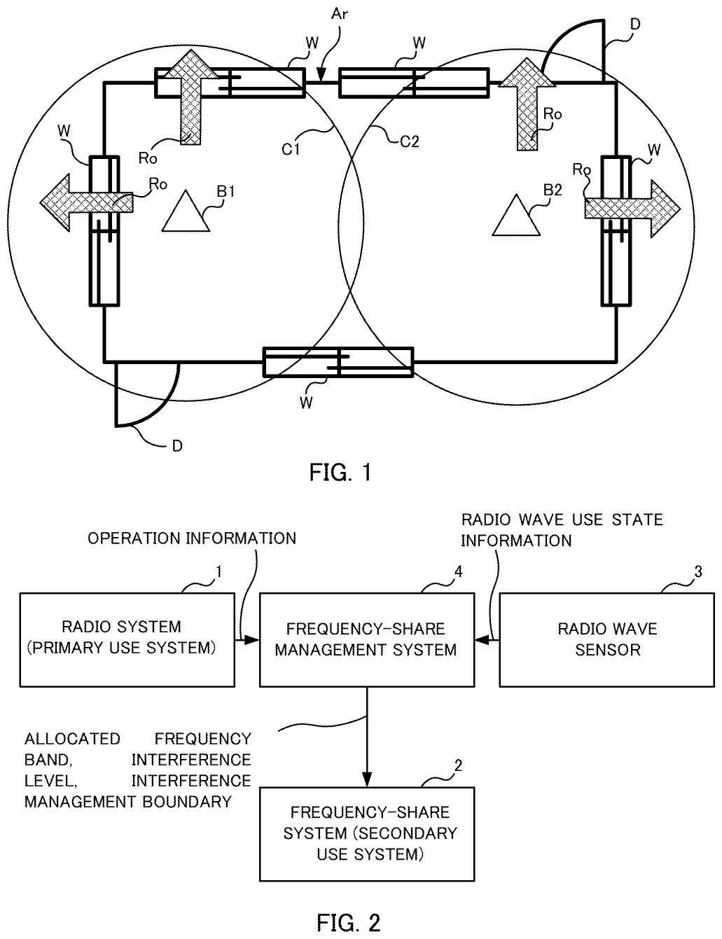

FIG. 1 is a diagram illustrating an example of a limited area in which radio base stations of a secondary use system are provided. In FIG. 1, limited area Ar and radio base stations B1 and B2 of a secondary use system provided in limited area Ar are illustrated. Note that, a primary use system is built outside of limited area Ar in FIG. 1.

In limited area Ar of FIG. 1 is a room provided with two doors D and four windows W.

Radio base stations B1 and B2 in FIG. 1 communicate with terminals (not illustrated) present in coverage areas C1 and C2, respectively.

The radio waves radiated from radio base stations B1 and B2 may leak outside of limited area Ar as indicated by, for example, arrows Ro.

The radio waves radiated from radio base stations B1 and B2 that share the frequency band with the primary use system and leaking outside of limited area Ar (e.g., arrows Ro in FIG. 1) possibly provide interference to the primary use system. For this reason, it is desired to suppress the radio waves leaking outside of limited area Ar.

The current methods for building radio systems, however, primarily focus on ensuring the radio communication quality within a limited area, and no consideration is made for interference to the outside of the limited area.

A non-limiting example of the present disclosure describes building of a radio system taking into account interference to the outside of a limited area.

FIG. 2 is a diagram illustrating an exemplary system configuration according to Embodiment 1.

The system configuration illustrated in FIG. 2 includes radio system 1, frequency-share system 2, radio wave sensor 3, and frequency-share management system 4.

Radio system 1 is a radio system used inside and outside of a limited area, for example. Radio system 1 may include a radio base station and a terminal that perform radio communication, using a certain frequency band. Radio system 1 may further include a control apparatus (e.g., server) that controls the radio base station. The radio base station of radio system 1, for example, outputs operation information including information on the frequency band being used, information on the number of terminals connected to the radio base station, and/or the like to frequency-share management system 4. Radio system 1 may be referred to as a “primary use system 1.”

Frequency-share system 2 is a radio system that at least partly shares the frequency band used by radio system 1. Frequency-share system 2 may include a radio base station and a terminal that perform radio communication using a frequency band that includes at least some of the frequency band used by radio system 1. Frequency-share system 2 may further include a control apparatus (e.g., server) that controls the radio base station. The information on the frequency band used by frequency-share system 2 may be indicated by frequency-share management system 4, for example. Frequency-share system 2 may be referred to as a “secondary use system 2.”

Radio wave sensor 3 is provided inside and/or outside of a limited area. Radio wave sensor 3 detects a radio wave radiated from a radio base station of radio system 1, for example. Radio wave sensor 3 then outputs information on a use state of the radio wave in the frequency band used by radio system 1 to frequency-share management system 4.

Frequency-share management system 4 includes one or more control apparatuses and provides information to frequency-share system 2 based on information acquired from radio system 1 and radio wave sensor 3.

Frequency-share management system 4, for example, allocates a frequency band and radio specifications and/or the like to be used in frequency-share system 2, based on the operation information acquired from radio system 1 and the information on the use state of a radio wave acquired from radio wave sensor 3, for example. Then, frequency-share management system 4 outputs information indicating the allocated frequency band, radio specifications, and/or the like to frequency-share system 2. An interference level and an interference management boundary for radio system 1 may be output. Details will be given, hereinafter.

In Embodiment 1, a description will be given of an information processing apparatus that determines placement of a radio base station of frequency-share system 2 in a case where frequency-share system 2 built in a certain limited area.

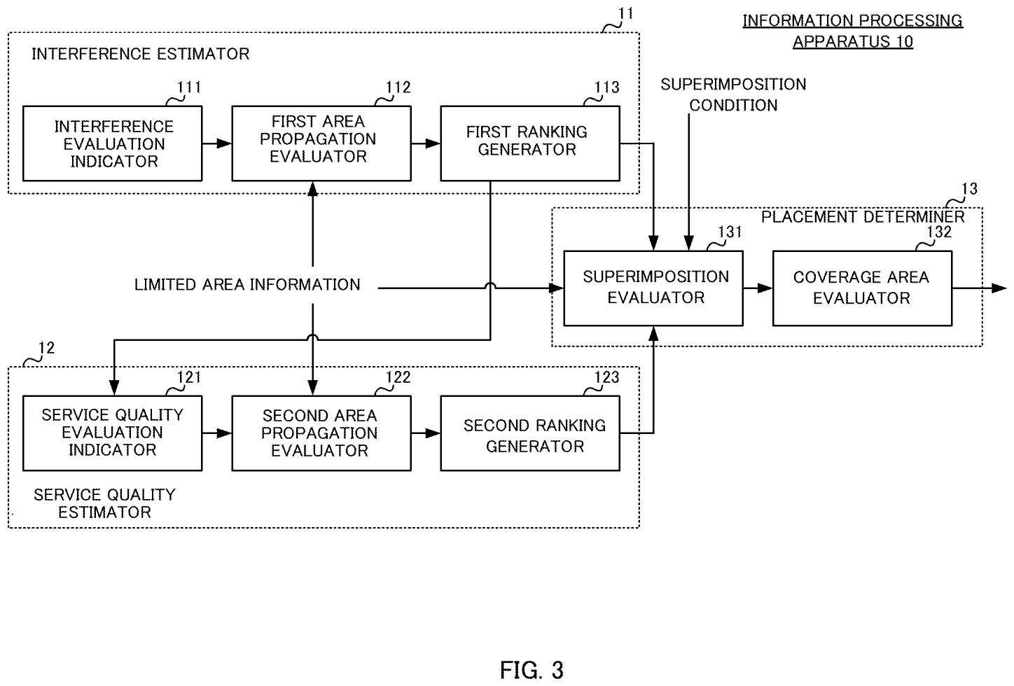

FIG. 3 is a block diagram illustrating an exemplary configuration of information processing apparatus 10 according to Embodiment 1. Information processing apparatus 10 illustrated in FIG. 3 includes interference estimator 11, service quality estimator 12 and placement determiner 13. Note that, information processing apparatus 10 may be configured of a computer, such as a personal computer (PC), a for example.

Interference estimator 11 determines, in limited area Ar, a first evaluation result on a radio wave intruding (or entering) into limited area Ar from outside of limited area Ar. The first evaluation result may be a heat map representing a power distribution of a radio wave intruding into limited area Ar at each position in limited area Ar, for example. The first evaluation may be considered as an example of an evaluation on interference.

Interference estimator 11 includes interference evaluation indicator 111, first area propagation evaluator 112, and first ranking generator 113. Note that, the processing of each functional block will be described, hereinafter.

Service quality estimator 12 configures a candidate for a position of a radio base station in limited area Ar. Service quality estimator 12 then determines a second evaluation result on a radio wave radiated from a radio base station in limited area Ar when the radio base station is placed at the configured candidate. The second evaluation result may be a heat map representing a power distribution of a radio wave radiated from the radio base station in limited area Ar, for example.

Service quality estimator 12 includes service quality evaluation indicator 121, second area propagation evaluator 122, and second ranking generator 123. Note that, the processing of functional blocks will be described, hereinafter.

Placement determiner 13 determines information on the placement position of a radio base station (e.g., coordinates of the placement position of radio base station) based on the first evaluation result and the second evaluation result. Placement determiner 13 outputs information on the determined placement position of the radio base station (e.g., coordinates of the placement position of radio base station). An administrator (user) to build frequency-share system 2 in a limited area, for example, places the radio base station based on the output information.

Placement determiner 13 includes superimposition evaluator 131 and coverage area evaluator 132. Note that, the processing of functional blocks will be described, hereinafter.

Information processing apparatus 10 makes an evaluation on the interference (interference given to the others) given to the outside of the limited area, and an evaluation on the quality of a communication service provided within the limited area. Information processing apparatus 10 then performs an evaluation integrating the results of these two evaluations and determines placement of the radio base station of frequency-share system 2.

Note that, the configuration illustrated in FIG. 3 may be included in apparatuses different from each other. A first information processing apparatus may include interference estimator 11 and a second information processing apparatus may include service quality estimator 12 and placement determiner 13. In this case, the first information processing apparatus may output the evaluation on the interference (interference given to the others) given to the outside of the limited area to the second information processing apparatus, and the second information processing apparatus may determine the placement of the radio base station of frequency-share system 2, for example.

In addition, the configuration of two or more functional blocks illustrated in FIG. 3 may be replaced by a configuration of one functional block. First area propagation evaluator 112 and second area propagation evaluator 122 may be replaced by a single evaluator, for example. First ranking generator 113 and second ranking generator 123 may be replaced by a single processor (e.g., single ranking generator), for example.

### Evaluation on Interference (e.g., Interference Given to the Others)

A description will be first given of an example of an evaluation on interference to the outside of a limited area, which is executed in interference estimator 11. In interference estimator 11, a radio wave intruding from the outside of a limited area toward the inside of the limited area is evaluated. The strength (e.g., power) of a radio wave is evaluated, which arrives the inside of the limited area from the direction where the radio wave that causes interference is radiated from the outside of the limited area, for example. Interference estimator 11 estimates, using a radio wave propagation simulation or the like, a radio wave which is radiated from a transmission point virtually provided outside the limited area (hereinafter, may be referred to as “virtual transmission point”) and which intrudes into the limited area, for example. Note that, the radio wave radiated from the virtual transmission point may be the same as the radio wave radiated by a radio base station of the secondary use system. The position where the estimated strength of the radio wave is equal to or less than a predetermined level is configured to be a candidate for the position where the radio base station is placed.

Interference evaluation indicator 111 instructs first area propagation evaluator 112 to perform evaluation on interference (e.g., interference given to the others). Further, interference evaluation indicator 111 outputs a parameter relating to the evaluation on interference to first area propagation evaluator 112. The parameter relating to the evaluation on interference includes a parameter for an interference management boundary provided outside of the limited area and information on placement of a virtual transmission point to be placed on the interference management boundary, for example. The interference management boundary is a boundary for placing a virtual transmission point of a radio wave intruding toward the inside of a limited area for the evaluation on interference. The interference management boundary may be referred to as a limited area boundary or a site boundary.

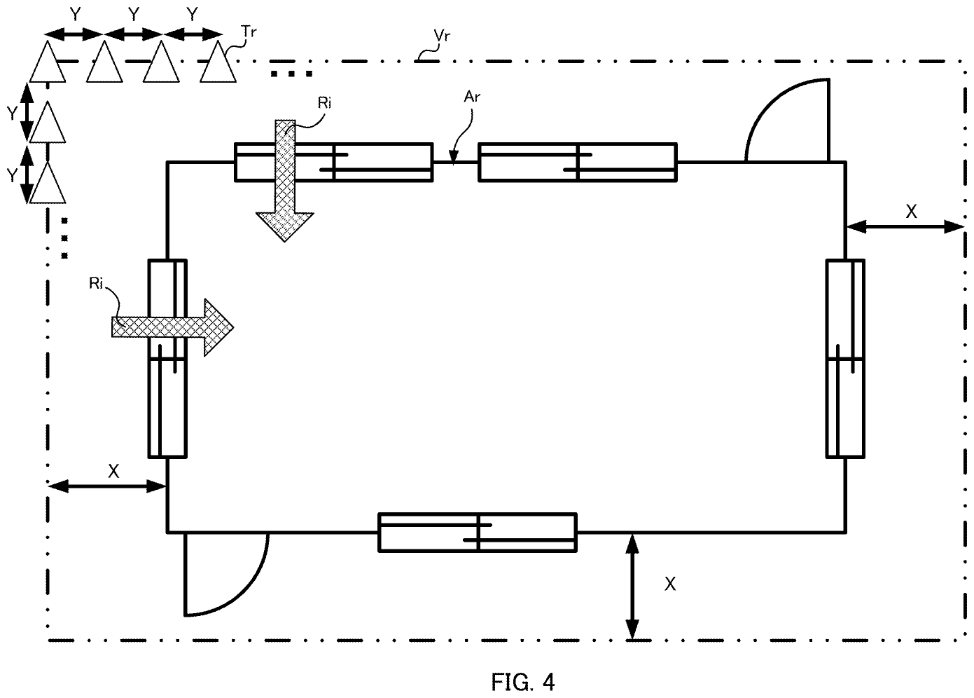

FIG. 4 is a diagram illustrating an exemplary interference management boundary in Embodiment 1. In FIG. 4, an example of interference management boundary Vr for limited area Ar as in FIG. 1 is illustrated.

The interference management boundary and interference level are specified from frequency-share system 2, for example.

Note that, the interference management boundary may be the same as the outer circumference of a limited area. Alternatively, when the limited area is indoors, the interference management boundary may be the outer circumference of the site.

As illustrated in FIG. 4, virtual transmission points Tr (e.g., radio base stations) of a radio wave are placed on interference management boundary Vr. Each “X” in FIG. 4 represents the distance from limited area Ar, and each “Y” represents an interval between virtual transmission points Tr, herein. In addition, arrows “Ri” in FIG. 4 each indicate a radio wave which is radiated from virtual transmission point Tr provided on interference management boundary Vr and which intrudes into limited area Ar.

“X” and “Y” may be adjusted in accordance with at least one of a shape of the limited area, a frequency band used by frequency-share system 2, and/or the computational complexity in information processing apparatus 10. Further, “X” and/or “Y” are/is not limited to a single value. “Y” representing an interval between virtual transmission points Tr need not be constant, for example.

In a case where the frequency band used by frequency-share system 2 is a 28-GHz band, for example, virtual transmission points may be arranged at intervals of 50 centimeters on 2 meters outside the limited area of a 10-meter square, for example. That is, in this case, “X” may be set equal to 2[m] and “Y” may be set equal to 50[cm].

First area propagation evaluator 112 then determines, based on limited area information, a power distribution of a radio wave that has been radiated with a predetermined power from a virtual transmission point provided on the interference management boundary and that has intruded into the limited area. The limited area information is, for example, information on a two-dimensional (or three-dimensional) model that facilitates an evaluation of a radio wave propagation in the limited area, for example. The limited area information may include information on a shape and material of walls surrounding the limited area. The limited area information may further include information on positions, quantities, shapes, and materials of a window and door provided in the limited area. The limited area information may further include a position, size, shape, and material of a shielding object in the limited area (e.g., wall and/or partition used for division inside of the limited area.

First ranking generator 113 then determines the rank of the determined power.

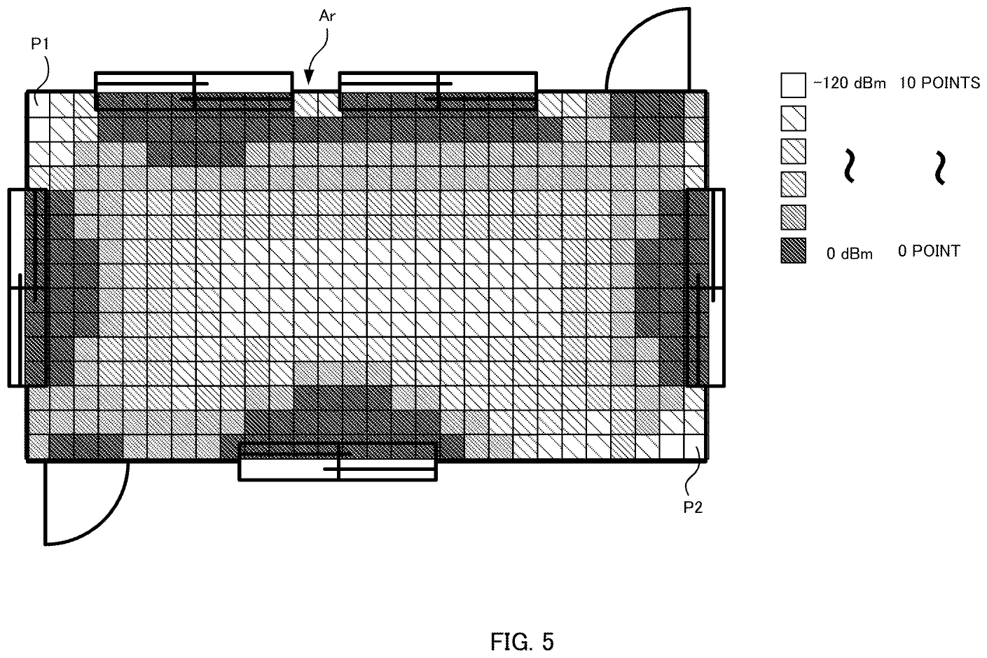

FIG. 5 is a diagram illustrating an exemplary evaluation result on interference in Embodiment 1. In FIG. 5, for example, a heat map of a power distribution of radio waves that have been radiated from virtual transmission points Tr illustrated in FIG. 4 and have intruded into the limited area Ar is illustrated for each square of a mesh grid, for example. The size of each square of the grid is, for example, 50[cm]×50[cm].

In FIG. 5, as an example, the magnitude of the power ranked from −120[dBm] to 0[dBm] is indicated by shading of the squares of the grid. Note that, in FIG. 5, the higher the rank, the lower the power is.

A position where the power of a radio wave intruding from outside toward inside of the limited area is low may correspond to a situation where a power of a radio wave in the direction in which release from the position to the outside of the limited area is made is small. In other words, the location of a radio base station where a radio wave is likely to be released from the inside of the limited area to the outside thereof may correspond to a location where a radio wave easily arrives from the outside of the limited area to the inside thereof.

In points P1 and P2 in FIG. 5, for example, the power of a radio wave intruding toward the inside of limited area Ar is small compared with other points. In other words, the powers of radio waves radiated from the outside of limited area Ar by the radio base stations placed at points P1 and P2 are small compared with other points.

Note that, how the grid is divided and how the rank is divided in FIG. 5 are only exemplary, and the present disclosure is not limited to this example. The finer the granularity of the grid and/or the finer the granularity of the rank, the more appropriate placement of a radio base station can be determined.

In the manner described above, the evaluation on the interference given by radio waves radiated from every position in the limited area to the outside of the limited area need not be performed. For this reason, it is made possible to suppress a processing load relating to determination of placement of a radio base station.

### Evaluation on Service Quality

Next, a description will be given of an example of an evaluation on a service quality within a limited area, which is performed by service quality estimator 12.

Service quality estimator 12, for example, estimates, using a radio wave propagation simulation and/or the like, an index representing the service quality within a limited area of a case where a radio base station is placed in any one or more of the candidates for the position configured in an evaluation on interference. In a case where the estimated service quality satisfies a predetermined quality, the placement of the radio base station corresponding to the estimated service quality is determined to be the placement of a base station that satisfies the service quality.

Service quality evaluation indicator 121 of service quality estimator 12, for example, selects an evaluation target placement from candidates for a position of a radio base station based on the ranks of the squares of the grid within the limited area, which are generated in first ranking generator 113. For example, service quality evaluation indicator 121 configures the position of a square of the grid where the rank is the top (largest point) as a candidate for the position of a radio base station, and selects one or more positions to be the evaluation target placement from among the configured candidates.

Second area propagation evaluator 122 of service quality estimator 12 then determines an evaluation result on a service quality of a case where a radio base station is placed at the selected evaluation target position. As an example, second area propagation evaluator 122 determines the power within a limited area for a radio wave radiated by the radio base station placed at a selected evaluation target position.

Second ranking generator 123 of service quality estimator 12 then determines the rank of the power within the limited area.

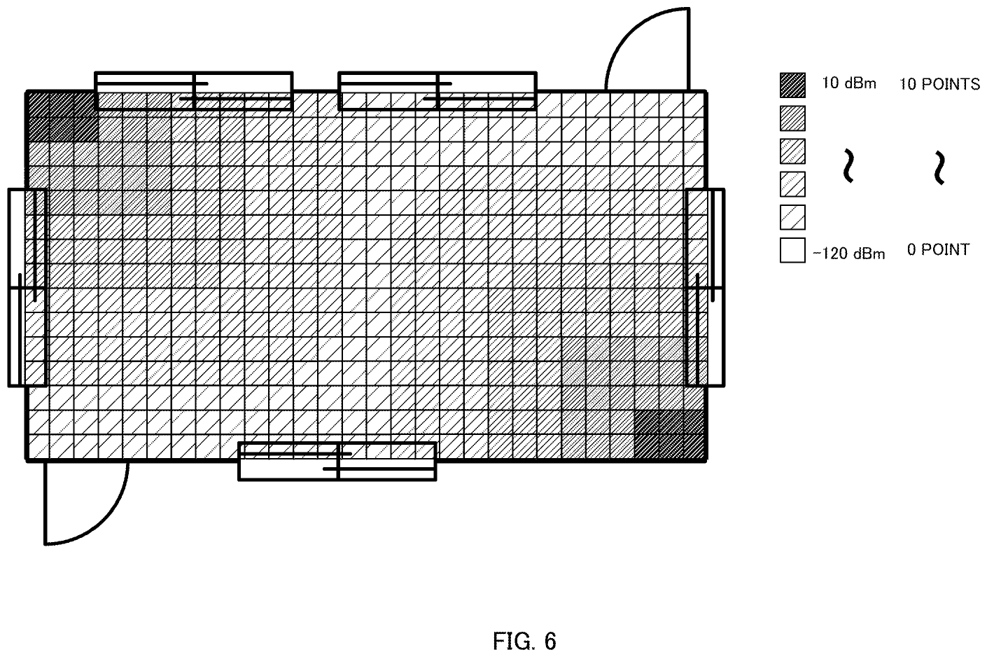

FIG. 6 is a diagram illustrating an example of an evaluation result on a service quality in Embodiment 1. In FIG. 6, in the same area as in FIGS. 4 and 5, a heat map of reception power of radio waves radiated by radio base stations placed at points P1 and P2 illustrated in FIG. 5 is illustrated for each square of the grid.

In FIG. 6, as an example, the magnitude of the powers ranked from 10[dBm] to −120[dBm] is illustrated by shading of the squares of the grid. Note that, in FIG. 6, the higher the rank, the greater the power is.

The index representing a service quality is not particularly limited. The index representing a service quality may be a reception power within a limited area or a throughput within a limited area.

Second ranking generator 123, for example, may determine that the estimated service quality satisfies a predetermined quality when the sum of reception powers of squares of the grid or the sum of the throughputs of squares of the grid is greater than or equal to a predetermined level. Second ranking generator 123, for example, adds the ranks given to reception powers of squares of the grid in the limited area and determines the result of addition as an evaluation result on the service quality for the evaluation target placement.

Further, when the index representing the service quality is a throughput, second ranking generator 123 may determine that a square of a grid indicating a throughput greater than or equal to a predetermined value (e.g., 10 points) to be a high rank. In this case, second ranking generator 123 may determine that a square of a grid indicating a throughput less than a predetermined value (e.g., 0 point) to be a low rank. Second ranking generator 123 may then add the ranks of the squares in the limited area and determine the result of addition to be the evaluation result on the service quality for the evaluation target placement.

The evaluation on a service quality is not limited to the examples described above. The placement of a radio base station for which the sum of reception powers in a limited area indicates the highest, for example, may be determined to be the placement for the base station that satisfies the service quality. Alternatively, the placement of a radio base station for which the minimum value of reception power in a limited area indicates a threshold or greater, for example, may be determined to be the placement for the base station that satisfies the service quality. Alternatively, the placement of a radio base station for which a range where the throughputs indicate a predetermined level or greater in a limited area indicates the largest, for example, may be determined to be the placement for the base station that satisfies the service quality.

### Integrated Evaluation

Next, an example of determining the placement of a radio base station, which is made in placement determiner 13, will be described. Placement determiner 13, for example, determines the placement of a radio base station based on an evaluation result on interference and an evaluation result on a service quality. Placement determiner 13 performs an integrated evaluation, for example, by superimposing the evaluation result on interference and the evaluation result on a service quality, thereby determining the placement of the radio base station.

In superimposition evaluator 131 of placement determiner 13, for example, adds a rank given to the evaluation result on the interference illustrated in FIG. 5 and a rank given to the evaluation result on the service quality illustrated in FIG. 6 for each square of the grid, thereby making an integrated evaluation.

Note that, in the integrated evaluation, a superimposition condition may be configured, herein. The superimposition condition includes a condition of whether to prioritize, an evaluation result on interference or an evaluation result on service quality, and/or a condition of weighting on each of the evaluation results, for example.

Superimposition evaluator 131, for example, performs weighting addition for each square of a grid on the rank given to the evaluation result on interference illustrated in FIG. 5 and the rank given to the evaluation result on the service quality illustrated in FIG. 6, based on the superimposition condition. Superimposition evaluator 131 then outputs the result of the addition to coverage area evaluator 132.

Coverage area evaluator 132 determines whether or not a coverage area of the limited area is sufficient, based on the result of addition of the ranks of the respective squares of the grid in the limited area. Coverage area evaluator 132, for example, may determine that the coverage area of the limited area is sufficient when the result of addition of ranks is less than or equal to a threshold (i.e., when the result of addition of the ranks is a rank higher than the threshold). The meaning of the expression “coverage area is sufficient” may correspond to a case where both of the interference to the outside of the limited area and the service quality in the limited area satisfy a predetermined condition.

Note that, some of the components described above may be included in an apparatus different from information processing apparatus 10.

### Processing Flow Relating to Determination of Placement of Radio Base Station

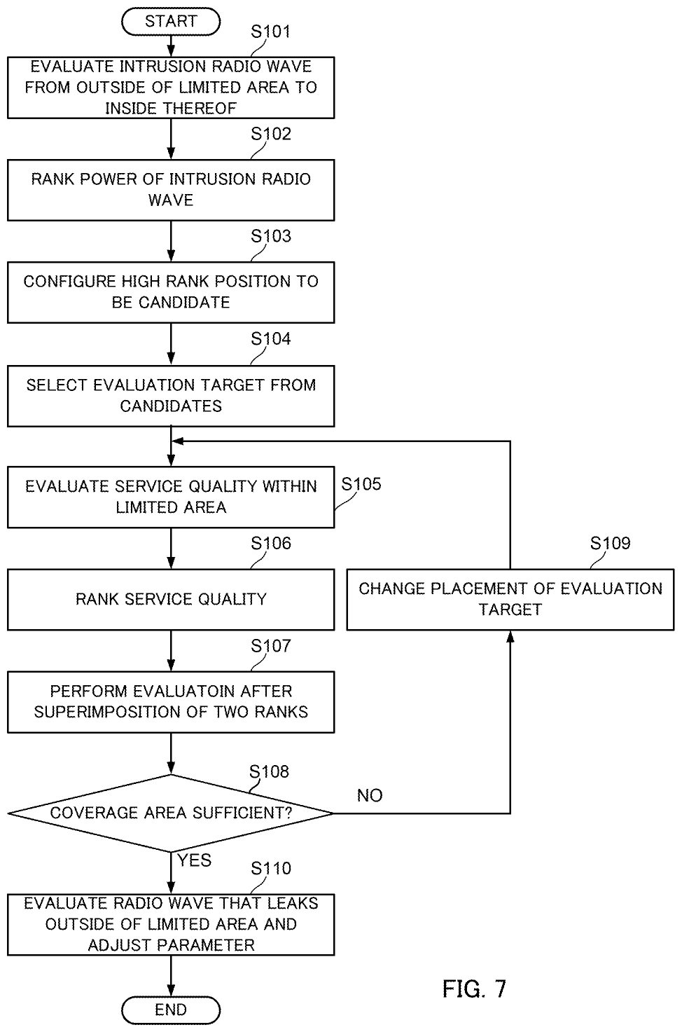

FIG. 7 is a flowchart illustrating an example of processing for determining placement of a radio base station in Embodiment 1. The processing illustrated in FIG. 7 starts based on an instruction from an administrator (user) who builds frequency-share system 2 in a limited area, for example. The administrator, for example, may provide the instruction to start the processing for determining placement of a radio base station via an operation unit included in information processing apparatus 10. The instruction entered into information processing apparatus 10 via the operation unit is provided to interference estimator 11, for example. Note that the administrator may enter information on limited area information and/or the like, in this case.

Interference estimator 11 evaluates an intrusion radio wave, which intrudes into the limited area from outside thereof (S101).

Interference estimator 11 ranks a reception power of an intrusion radio wave evaluated in the limited area (S102). A map for ranks of reception powers of intrusion waves (hereinafter, may be referred to as “interference rank”) is generated, herein.

Service quality estimator 12 configures a high rank position to be a candidate for a position of a radio base station in raking of S102 (S103).

Service quality estimator 12 selects placement of a radio base station of an evaluation target from among the configured candidates (S104).

Service quality estimator 12 evaluates the service quality in the limited area of a case where the radio base station is placed in the evaluation target placement (S105).

Service quality estimator 12 ranks the service qualities evaluated in the limited area (S106). A map for ranks on the service qualities is generated, herein.

Placement determiner 13 superimposes the map for ranks on the interference and the map for ranks on the service qualities one on top of another and evaluates the evaluation target placement based on a predetermined criterion (S107).

Placement determiner 13 evaluates whether the coverage area is sufficient (S108).

When the coverage area is not sufficient (No in S108), placement determiner 13 changes the evaluation target placement (S109). Changing the evaluation target placement herein includes an increase or decrease in the number of radio base stations to be placed, for example. Further, changing the evaluation target placement may include placing a radio base station having a difference performance, such as output. Alternatively, changing the evaluation target placement includes changing the position of the candidate. Further, changing the evaluation target placement includes changing a parameter (e.g., transmission power, directivity, and/or the like) on communication of the radio base station. Then, the flow shifts to S105.

When the coverage area is sufficient (YES in S108), placement determiner 13 evaluates a radio wave that leaks out to the outside of the limited area of a case where a radio base station is placed at the evaluation target placement and adjusts the parameter relating to the communication of the radio base station (S110). The flow then ends.

Information processing apparatus 10 can determine placement of a radio base station taking into account an evaluation on interference, through the processing described above.

Note that, the information acquirable during the processing described above (e.g., evaluation result on interference) may be output from information processing apparatus 10. In this case, information processing apparatus 10 may include an output for outputting the information acquirable during the processing described above. The information acquirable during the processing described above may be secondarily used via outputting of the information from information processing apparatus 10.

In addition, some of the processing described above may be performed by apparatuses different from each other. The first information processing apparatus may include interference estimator 11 and the second information processing apparatus may include service quality estimator 12 and placement determiner 13, for example. In this case, the first information processing apparatus may evaluate a distribution of radio waves (e.g., power distribution) intruding into the limited area when the radio waves are radiated from one or a plurality of virtual transmission points configured outside of the limited area. In addition, the first information processing apparatus may determine information on a candidate for a position of a radio base station to be placed inside of the limited area, based on the evaluation result on the distribution of radio waves. Then, the first information processing apparatus may output the information on a candidate for a position of a radio base station to be placed inside of the limited area to the second information processing apparatus, for example.

According to Embodiment 1 described above, it is made possible to take a radio wave radiated from an inside of a limited area to the outside of the limited area into account by taking into account the radio wave intruding into the limited area from the outside of the limited area, thus, making it possible to build a radio system taking into account interference to surroundings of a certain area.

Note that, in Embodiment 1, an example with an assumption that the limited area is a two-dimensional plane is illustrated, but the present disclosure is not limited to the example. The limited area may be, for example, a three-dimensional space including a height direction. In a case where the limited area is a three-dimensional space, an evaluation on interference and/or an evaluation on a service quality may be determined in the three-dimensional space.

### Embodiment 2

In Embodiment 2, a description will be given of an example of making an attempt for power saving on the processing load relating to determination of placement of a radio base station in Embodiment 1.

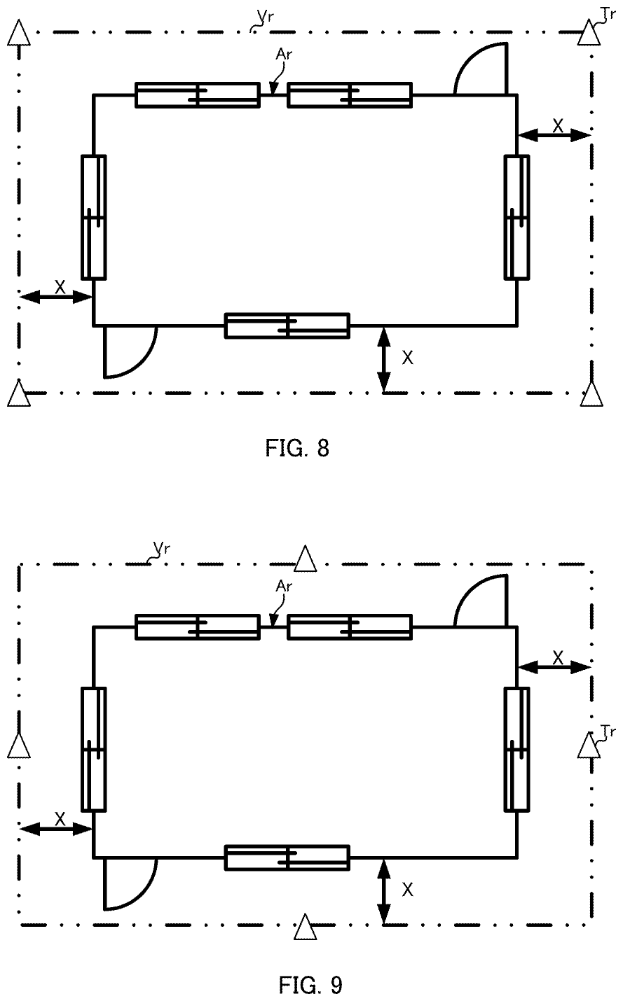

FIG. 8 is a diagram illustrating a first example of placement for virtual transmission points in Embodiment 2. FIG. 9 is a diagram illustrating a second example of placement for virtual transmission points in Embodiment 2. In FIGS. 8 and 9, as in FIG. 4, interference management boundary Vr provided for limited area Ar is illustrated. In FIGS. 8 and 9, the number of virtual transmission points Tr placed on interference management boundary Vr is small compared with FIG. 4.

In FIG. 8, virtual transmission points Tr are placed at the four corners of interference management boundary Vr. In FIG. 9, virtual transmission points Tr are placed at the centers of the four sides of interference management boundary Vr.

In Embodiment 2, an attempt for power saving on the proceeding load relating to determination of an evaluation on interference is made by reducing the number of virtual transmission points Tr. Note that, in this case, the evaluation on interference of a case where the number of virtual transmission points Tr is reduced may be converted to an evaluation on interference when the number of virtual transmission points Tr is sufficient (e.g., FIG. 4).

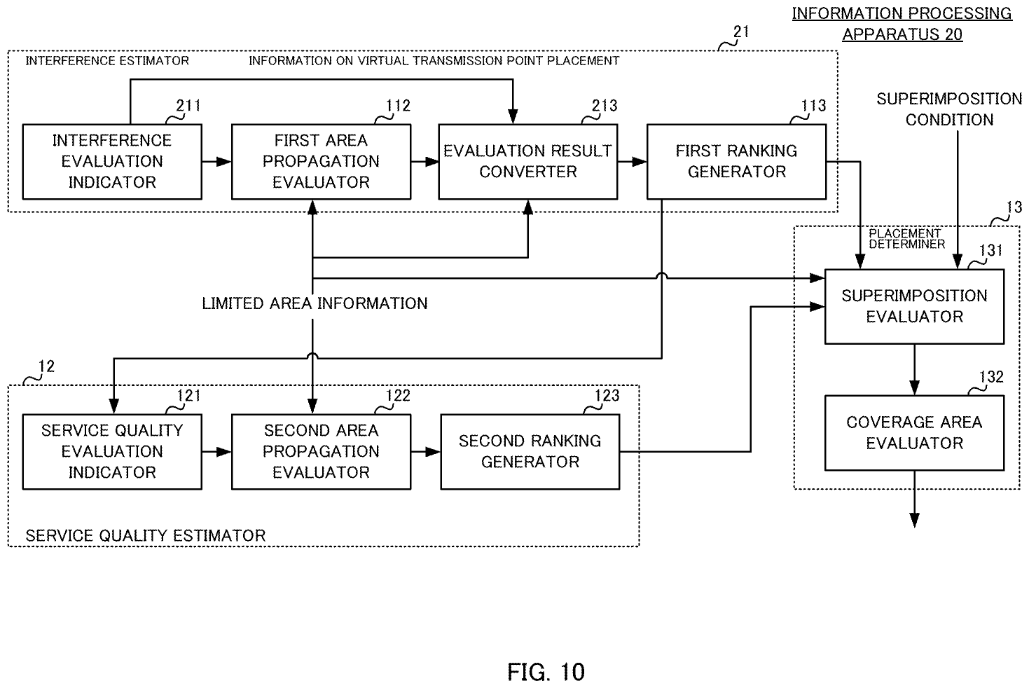

FIG. 10 is a block diagram illustrating an exemplary configuration of information processing apparatus 20 according to Embodiment 2. Note that, in FIG. 10, the same components as those in FIG. 3 are denoted by the same reference numerals, and a description thereof may be omitted.

In information processing apparatus 20 illustrated in FIG. 10, interference estimator 11 illustrated in FIG. 3 has been replaced by interference estimator 21.

Interference estimator 21 includes interference evaluation indicator 211, first area propagation evaluator 112, evaluation result converter 213, and first ranking generator 113.

Interference evaluation indicator 211 instructs first area propagation evaluator 112 to perform an evaluation on interference. Interference evaluation indicator 211 further outputs a parameter on the evaluation on interference to first area propagation evaluator 112. The parameter on the evaluation on interference includes a parameter relating to an interference management boundary provided outside of the limited area and information on placement of virtual transmission points placed outside of the interference management boundary. In Embodiment 2, as illustrated in FIGS. 8 and 9, virtual transmission points are sparsely placed compared with Embodiment 1.

Interference evaluation indicator 211 outputs, to evaluation result converter 213, information on placement of virtual transmission points to be placed on an interference management boundary.

Evaluation result converter 213 converts, based on the information on a limited area and information on placement of virtual transmission points, the power of radio waves that have intruded into the limited area, which is determined in first area propagation evaluator 112, into the power of radio waves that have intruded into the limited area of a case where the number of virtual transmission points is sufficient (e.g., in case of FIG. 4). In other words, evaluation result converter 213 converts an evaluation result on the interference evaluated when a certain number of virtual transmission points is configured (e.g., 4 in FIGS. 8 and 9) into an evaluation result on the interference evaluated in a case where a larger number of virtual transmission points than the certain number is configured (e.g., total number of virtual transmission points Tr illustrated in FIG. 4). The conversion of the evaluation result in evaluation result converter 213 may be considered as an interpolation for an evaluation not made with a sufficient number of virtual transmission points.

Note that, the method for conversion in evaluation result converter 213 is not limited particularly. Evaluation result converter 213, for example, determines a power distribution of radio waves that have intruded into the limited area determined in first area propagation evaluator 112 to be a power distribution shifted in accordance with a predetermined condition. Evaluation result converter 213 may then determine the power distribution of radio waves that have intruded into the limited area of a case where the number of virtual transmission points is sufficient (e.g., in case of FIG. 4) by superimposing a plurality of shifted power distributions one on top of another. Examples of the predefined condition include a condition of shifting in a certain direction in parallel and a condition of rotationally shifting at a certain angle. The predetermined condition may be determined based on information on the limited area and information on placement of virtual transmission points, for example.

Then, evaluation result converter 213 outputs the result of conversion to first ranking generator 113.

According to Embodiment 2, reducing the number of virtual transmission points with the configuration illustrated in FIG. 10, for example, makes it possible to enable power saving for the processing load relating to determination of an evaluation on interference and thus to achieve power saving for the processing load relating to placement of a radio base station.

Note that, in each of the embodiments described above, a description has been given with an example in which a secondary use system that shares a frequency band with a primary use system takes into account the interference given by the secondary use system to the primary use system, but the present disclosure is not limited to this example. The present disclosure may also be applied to a case where interference between two or more secondary use systems that share a frequency band is taken into account, for example. In this case, placement of a radio base station may be determined in each of the two or more secondary use systems as in the embodiments described above.

Note that, the information processing apparatus in each of the embodiments described above may be configured as a computer apparatus including a processor, a memory, a storage unit, a communication device, an input device, an output device, a bus, and/or the like.

Note that, in each of the embodiments described above, the expression “a radio wave that intrudes (or enters) into an area” may be replaced with another expression, such as “a radio wave incident in an area” or “a radio wave propagates into an area.”

Note that, the term, such as “part” or “portion” or the term ending with a suffix, such as “-er” “-or” or “-ar” in the above-described embodiment may be replaced with another term, such as “circuit (circuitry),” “device,” “unit,” or “module.”

The term “frequency band” in the above embodiments may be replaced with another term, such as “frequency,” “frequency channel,” “band,” “carrier,” “subcarrier,” or “(frequency) resource.”

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. Further, an FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health care and/or medicine prescription) device, and a vehicle providing communication functionality or a transportation system (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, and/or the like, and various combinations thereof.

The communication apparatus may comprise a device, such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Various embodiments have been described with reference to the drawings hereinabove. Obviously, the present disclosure is not limited to these examples. Obviously, a person skilled in the art would arrive at variations and modification examples within a scope described in claims, and it is understood that these variations and modifications are within the technical scope of the present disclosure. Further, each component of the above-mentioned embodiments may be combined optionally without departing from the spirit of the disclosure.

Specific examples of the present disclosure have been described thus far, but these examples are only exemplary, and are not to limit the claims. Techniques recited in the claims include, for example, variations and/or modifications of the specific examples exemplified above.

The disclosure of Japanese Patent Application No. 2020-000280, filed on Jan. 6, 2020, including the specification, drawings, and abstract is incorporated herein by reference in its entirety.

### INDUSTRIAL APPLICABILITY

The present disclosure is suitable for radio communication systems.

### REFERENCE SIGNS LIST

10, 20 Information processing apparatus

11, 21 Interference estimator

12 Service quality estimator

13 Placement determiner

111, 211 Interference evaluation indicator

112 First area propagation evaluator

122 Second area propagation evaluator

113 First ranking generator

123 Second ranking generator

121 Service quality evaluation indicator

131 Superimposition evaluator

132 Coverage area evaluator

213 Evaluation result converter

1. An information processing apparatus, comprising:
a first evaluator that evaluates a distribution of a first radio wave intruding into a certain area when a radio wave is radiated from one or a plurality of transmission points configured outside of the certain area; and
a determiner that determines information on a placement candidate position of a radio base station to be placed inside of the certain area, based on an evaluation result on the distribution of the first radio wave.

2. The information processing apparatus according to claim 1, further comprising a second evaluator that evaluates a distribution of a radio quality inside of the certain area when a second radio wave is radiated from a candidate point configured at the placement candidate position inside of the certain area, wherein
the determiner determines information on a placement position of the radio base station inside of the certain area, based on an evaluation result on the distribution of the radio quality and the evaluation result on the distribution of the first radio wave.

3. The information processing apparatus according to claim 2 further comprising an output that outputs at least one of an evaluation result by the first evaluator, an evaluation result by the second evaluator and/or a result of the determination by the determiner.

4. The information processing apparatus according to claim 1, wherein the determiner configures a position where a power of the first radio wave is less than or equal to a predetermined level to be the placement candidate position.

5. The information processing apparatus according to claim 1, wherein the first evaluator converts the evaluation result of the distribution of the first radio wave evaluated in a case where a first number of transmission points is configured, into a distribution of the first radio wave of a case where a second number of transmission points is configured, the second number being greater than the first number.

6. An information processing method, comprising:
evaluating, by an information processing apparatus, a distribution of a first radio wave intruding into a certain area when a radio wave is radiated from one or a plurality of transmission points configured outside of the certain area; and
determining, by the information processing apparatus, information on a placement candidate position of a radio base station to be placed inside of the certain area, based on an evaluation result on the distribution of the first radio wave.

7. A program causing an information processing apparatus to execute processing comprising:
evaluating a distribution of a first radio wave intruding into a certain area when a radio wave is radiated from one or a plurality of transmission points configured outside of the certain area; and
determining information on a placement candidate position of a radio base station to be placed inside of the certain area, based on an evaluation result on the distribution of the first radio wave.
